(19) United States
(12) Patent Application Publication
(10) Pub. No.: US 2020/0026100 A1
(43) Pub. Date: Jan. 23, 2020

(54) EYEWEAR FLOATATION DEVICE

(71) Applicant: Richard LeRoy Penberthy, JR., Hayes, VA (US)

(72) Inventor: Richard LeRoy Penberthy, JR., Hayes, VA (US)

(21) Appl. No.: 16/515,715

(22) Filed: Jul. 18, 2019

Related U.S. Application Data
(60) Provisional application No. 62/700,578, filed on Jul. 19, 2018.

(51) Int. Cl. G02C 11/00

(52) U.S. Cl. CPC G02C 11/00

(57) ABSTRACT

An eyewear flotation device is provided. The eyewear flotation device includes a first open sleeve and a second closed sleeve joined substantially along a longitudinal outer periphery of each sleeve. The first sleeve is dimensioned and adapted to slidably receive a temple portion of an eyewear wherein the closed sleeve houses a floatation material adapted to be buoyant in water. One eyewear floatation device may be slid along each temple portion of the eyewear so that the closed sleeve is outwardly facing along the same temple portion, thereby enabling the eyewear to float on the water.

### CROSS-REFERENCE TO RELATED APPLICATION

This application claims the benefit of priority of U.S. provisional application No. 62/700,578, filed 19 Jul. 2018, the contents of which are herein incorporated by reference.

### BACKGROUND OF THE INVENTION

The present invention relates to eyewear accessories and, more particularly, to an eyewear floatation device or a pair thereof. Each eyewear flotation device includes a first open sleeve dimensioned and adapted to slidably receive the temple or arm portion of an eyewear and a closed sleeve joined substantially along a longitudinal outer periphery of the open sleeve, wherein the closed sleeve houses a floatation material adapted to be buoyant in water.

For individuals wearing glasses or eyewear, such as prescription glasses, sunglasses or the like, being out in or on the water entails an additional concern: that of the eyewear falling off and sinking in the water. Currently, floatable sunglasses are available, but most people want their favorite brand of sunglasses rendering this solution moot. Additionally, name-brand sunglasses and prescription eyewear can be expensive, making owning a second, floatable pair prohibitively expensive. Other items in this field connect to the eyewear with snap-on or other connection devices that can scratch or damage the eyewear. While other solutions are uncomfortable to wear, causing discomfort to the wear at a time of leisure and play.

As can be seen, there is a need for a new and non-obvious eyewear floatation device. Each eyewear flotation device embodied by the present invention includes an open sleeve dimensioned and adapted to slidably receive a temple portion of eyewear and a closed sleeve joined substantially along a longitudinal outer periphery of the open sleeve, wherein the closed sleeve houses a floatation material adapted to be buoyant in water. One eyewear floatation device may be slid along each temple portion of the eyewear so that the closed sleeve is outwardly facing along the same temple portion, thereby enabling the eyewear to float on the water. The present invention does not harm the eyewear, and the second sleeve is on the outer side of the temple portions, in front of the ear of the wearer, so as not cause discomfort to the wearer. Nor is it a strap that goes around the back of your head and hitting your neck all day. Furthermore, the open sleeve may be a smooth channel of performance fabric to slide onto the temple portion while the closed sleeve is on a separate channel on the outside of the temple portion and not against the wearer's head. The present invention will be available in a variety of colors to either blend in with the eyewear and/or stand out in the water.

### SUMMARY OF THE INVENTION

In one aspect of the present invention, an eyewear floatation device includes the following: a first sleeve open on both ends; a second sleeve closed on both ends; a floatation material housed in the second sleeve; and the first and second sleeves joined along a substantial portion of outer peripheries of thereof, wherein a lumen of the first sleeve is dimensioned to snugly receive a temple portion of an eyewear, and wherein a fabric of the first sleeve comprises a thickness between 1/32 and ⅛ of an inch.

In another aspect of the present invention, a method of making eyewear buoyant in water, includes the following: providing at least one of the above-mentioned eyewear floatation device; providing an eyewear having two temple portions; sliding one of the two temple portions through said lumen of the at least one eyewear floatation device; and orienting the second sleeve so as to be disposed not between the two temple portions.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a perspective view of an exemplary embodiment of the present invention;

FIG. 3 is a top view of an exemplary embodiment of the present invention;

FIG. 4 is a section view of an exemplary embodiment of the present invention, taken along line 4-4 of FIG. 3;

FIG. 5 is an exploded perspective view of an exemplary embodiment of the present invention, illustrating placement of a first sleeve 12 onto a temple portion 20; and

FIG. 6 is a section view of an exemplary embodiment of the present invention, taken along line 6-6 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an eyewear flotation device. The eyewear flotation device includes a first open sleeve and a second closed sleeve joined substantially along a longitudinal outer periphery of each sleeve. The first sleeve is dimensioned and adapted to slidably receive a temple portion of an eyewear wherein the closed sleeve houses a floatation material adapted to be buoyant in water. One eyewear floatation device may be slid along each temple portion of the eyewear so that the closed sleeve is outwardly facing along the same temple portion, thereby enabling the eyewear to float on the water.

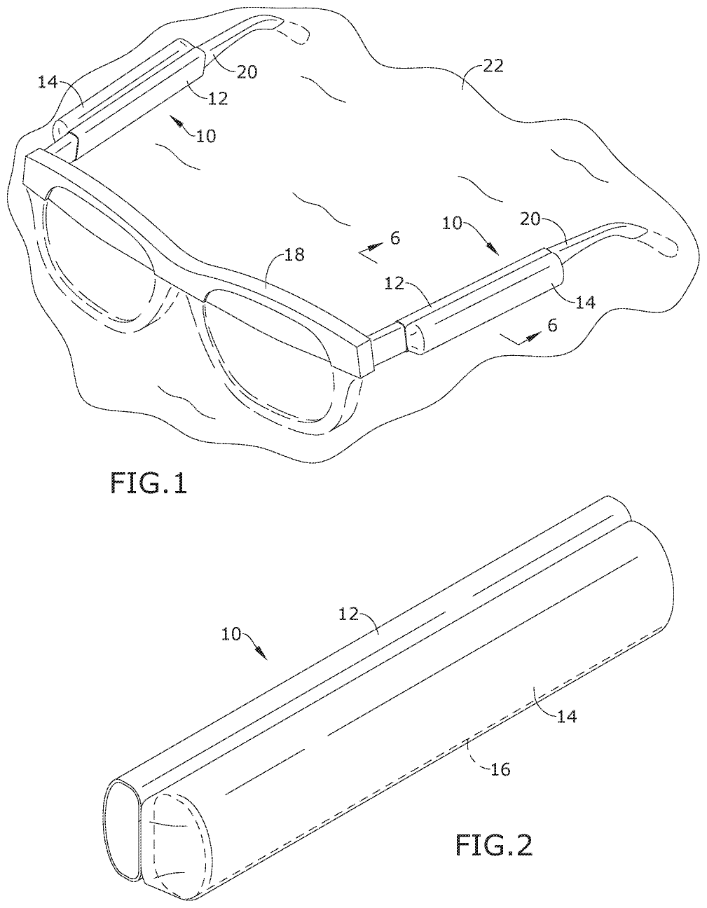

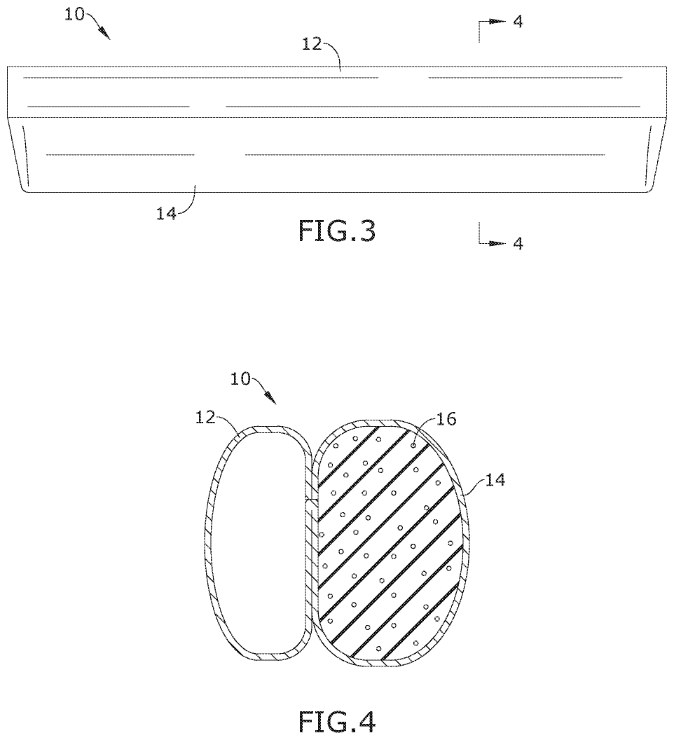

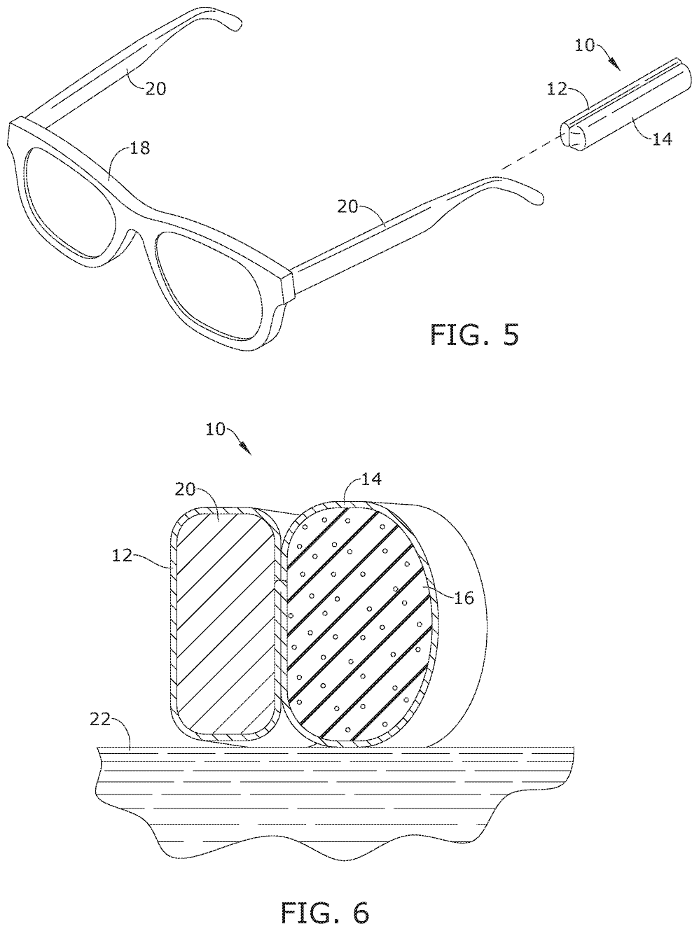

Referring to FIGS. 1 through 6, the present invention may include an eyewear flotation device 10. The eyewear flotation device 10 includes a first sleeve 12 and a second sleeve 14 substantially joined along longitudinal outer peripheries of both. The first sleeve 12 may be tubular and open on both ends, providing a lumen dimensioned and adapted to slidably receive a temple portion 20 of an eyewear 18. The second sleeve 14 may house a flotation material 16, such as foam, so that the eyewear flotation device 10 and an operatively associated eyewear 18 floats in water 22. The floatation material 16 may include a ⅜″ backer rod, closed cell.

A method of making the present invention may include the following. A performance fabric, such as Nylon (86%)/Spandex (14%), 5.5 oz, having a thickness ranging between 1/32 and ⅛ of an inch may be cut into a rectangle and then sewn with fabric thread (natural or synthetic) to close into a tubular cylinder and then inverted to ensure that the seam is on the inside and the correct side of the performance fabric is on the outside. Then the fabric cylinder shape may then be sewn with fabric thread to make a dual cylinder chamber sleeve design. One second sleeve 14/chamber has a piece of the floatation material 16 inserted into it and tacked shut with stitches of the fabric thread to ensure that it does not come out. The first sleeve 12/chamber that is not filled with foam is left open to allow the temple portions 20 of the eyewear 18 to pass therethrough without scratching while the engagement with the temple portion 20 is snug to ensure that it will not come off.

The performance fabric allows the present invention to stretch over the temple portions 20 of the eyewear 18 without damaging or harming the sunglasses and is adapted to quickly dry out once the not in any type of water 22. With this design the floatation material 16 will sit on the side of the temple portions 20 thereby not interfering with the wearer's peripheral vision and provide the widest possible buoyant structure to reduce the chance of the eyewear 18 tipping while floating in the water 22.

A method of using the present invention may include the following. The eyewear floatation device 10 disclosed above may be provided. A user may slide one eyewear floatation device 10 on each temple portion 20 of their eyewear 18, or at least one eyewear floatation device 10 on one temple portion 18. Each temple portion 18 slides through the first sleeve 12 so that the associated second sleeve 14 is not between the two temple portions 20. In certain embodiments, the wearer may orient the second sleeve 14 so that it is upward facing.

It should be understood by those skilled in the art that the use of directional terms such as upper, lower, upward, downwardly, top and the like are used in relation to the illustrative embodiments as they are depicted in the figures, the upward direction (or upper) being toward the top of the corresponding figures and a downward direction being toward the bottom of the corresponding figures.

At this point the user is ready to enjoy their time on the water 22 without fear of their eyewear 18 sinking therein as the present invention enables the eyewear 18 to float thereon.

It should be understood, of course, that the foregoing relates to exemplary embodiments of the invention and that modifications may be made without departing from the spirit and scope of the invention as set forth in the following claims.

What is claimed is:

1. An eyewear floatation device, comprising:
a first sleeve open on both ends;
a second sleeve closed on both ends;
a floatation material housed in the second sleeve; and
the first and second sleeves joined along a substantial portion of outer peripheries of thereof.

2. The eyewear floatation device of claim 1, wherein a lumen of the first sleeve is dimensioned to snugly receive a temple portion of an eyewear.

3. The eyewear floatation device of claim 2, wherein a fabric of the first sleeve comprises a thickness between 1/32 and ⅛ of an inch.

4. A method of making eyewear buoyant in water, comprising providing at least one eyewear floatation device of claim 2;
providing an eyewear having two temple portions;
sliding one of the two temple portions through said lumen of the at least one eyewear floatation device; and
orienting the second sleeve so as to be disposed not between the two temple portions.
